(19) United States
(12) Patent Application Publication
(10) Pub. No.: US 2014/0340745 A1
(43) Pub. Date: Nov. 20, 2014

(54) 3D LENTICULAR DISPLAY METHOD AND APPARATUS

(71) Applicants: Michael Gibilisco, Longwood, FL (US); Dominic Crain, Longwood, FL (US)

(72) Inventors: Michael Gibilisco, Longwood, FL (US); Dominic Crain, Longwood, FL (US)

(21) Appl. No.: 14/279,937

(22) Filed: May 16, 2014

Related U.S. Application Data
(60) Provisional application No. 61/825,310, filed on May 20, 2013.

(51) Int. Cl. G02B 27/22

(52) U.S. Cl. CPC G02B 27/2214
USPC 359/463; 29/592.1

(57) ABSTRACT

This invention relates to a method of making a three dimensional image display and to the three dimensional image display. A lenticular array is laminated to a substrate for mounting to a registration riser for positioning the substrate and lens over a display, such as a television display. The lenticular lens is positioned to align the lenticular lens for viewing a 3D image on the play while the registration riser is sized to place the lenticular lens over the display focused on the display face. The substrate having the attached lens is attached to the registration riser which is removably attached to the display. The riser allows the precise registration of of the lens to be attached to the display without direct bonding to the display for ease in manufacture and removal and replacement.

This application claims the benefit of U.S. Provisional Application No. 61/825,310, filed May 20, 2013.

### TECHNICAL FIELD

The invention relates to a design to enable a high volume production yield of consumer and commercial lenticular lens based auto-stereoscopic 3D display devices. The invention is most advantageous for use with large format display devices, but can be used with smaller display devices as well.

### BACKGROUND OF THE INVENTION

A lenticular lens based auto-stereoscopic 3D device, while displaying imagery, refracts light from the pixels being displayed using lenses. As a result, different pixels are viewed depending on the location of the viewer's eyes who witness the observation. Accordingly, images entering through the right and left eye are at a different angle of view causing a binocular disparity between the images and creating a dimensional impression and/or perception of depth. The invention relates to a design to enable a high volume production yield of consumer and commercial lenticular lens based auto-stereoscopic 3D display devices. The present invention is most advantageous for use with large format display devices, such as 47 inches or greater, but can be used with smaller display devices as well. A typical display device includes a liquid crystal display (LCD), light-emitting diode (LED) display, organic light-emitting diode (OLED) display, or other pixelated display. A lenticular lens is one of the key components to the technology and has a precise alignment relationship with the pixel pitch of the display device and a set focal length that must be realized in order for the viewer to perceive the proper 3D impression. This relationship can cause the assembly of a lenticular lens based auto-stereoscope 3D display device (especially large format) to be tedious, cumbersome and time consuming. Conventionally, the lens requirements and production workflows have made it difficult for high volume production.

### SUMMARY OF THE INVENTION

This application relates to a method of making a three dimensional image display and to the three dimensional image display. The method includes selecting an image display panel, such as a television display screen, having a face for displaying visual images and then selecting a transparent substrate having predetermined registration alignment guides. A lenticular lens array is selected to cover the display panel and laminated to the transparent substrate. The substrate and lens are removably attached to a registration riser which is sized to fit around the periphery of the display panel and has a predetermined shape for spacing the substrate and attached lenticular lens array relative to the face of the display panel by a distance to focus the lenticular lens on the display panel. The substrate with the attached lenticular lens array is removably attached to the registration riser using predetermined registration alignment guides and the registration riser is removably attached to the display panel to cover the face of the display panel and positioned the lenticular lens for focusing on the face of the display panel to allow viewing of three dimensional images displayed on the display panel. This allows the lenticular lens to be removably mounted over the face of a display panel for easy removal and replacement without losing its alignment relative to the display panel. Three embodiments are illustrated for aligning the substrate and lens on the registration riser and include alignment guides using a plurality of alignment guide notches matching registration riser tabs and alignment guides having a plurality of alignment guide registration pin holes, matching registration riser pins and a plurality of alignment guides having a plurality of dog eared corners matching registration riser corners.

### BRIEF DESCRIPTION OF THE DRAWINGS

The accompanying drawings, which are included to provide further understanding of the invention and are incorporated in and constitute a part of the specification, illustrate an embodiment of the invention and together with the description serve to explain the principles of the invention.

In the drawings:

FIG. 1 is a perspective view of a lenticular lens array;

FIG. 2 is a diagrammatic view of a lenticular lens array mounted to a substrate;

FIG. 3 is a diagrammatic view of a lenticular lens array mounted to a substrate and to a display and having diagrammatic eyes positioned for viewing the display;

FIG. 4 is an exploded view of a 3D display in accordance with the present invention;

FIG. 5 is a diagrammatic view of a 3D display having the registration riser mounting the lens to the display panel;

FIG. 6 is a partial sectional view of the riser, lens and substrate positioned on the display panel;

FIG. 7 is one embodiment of a substrate having tab cutouts for registration alignment with the riser;

FIG. 8 is an embodiment of a substrate having a pin key registration for alignment with the riser;

FIG. 9 is an embodiment of a substrate having dog eared registration for alignment with the riser;

FIG. 10 illustrates the riser registration with the tab cutout of FIG. 7;

FIG. 11 illustrates the riser registration with the pin key alignment of FIG. 8;

FIG. 12 illustrates the riser registration with the dog ear alignment of FIG. 9;

FIG. 13 is a perspective of a riser in accordance with the present invention;

FIG. 14 is a second perspective of a riser in accordance with the present invention;

FIG. 15 is plan view of a riser layout;

FIG. 16 is a sectional view taken through one side of a riser; and

FIG. 17 is a sectional view taken through a narrow area of a tab on a riser.

### DETAILED DESCRIPTION OF AN EXEMPLARY EMBODIMENT

The invention will be described with reference to certain preferred embodiments. This invention may, however, be embodied in many different forms and should not be construed as limited to the embodiments set forth herein. Rather, these embodiments are provided so that this disclosure will convey preferred embodiments of the invention to those skilled in the art.

A typical display device includes a liquid crystal display (LCD), light-emitting diode (LED) display, organic light-emitting diode (OLED) display, or other pixelated display.

A lenticular lens is one of the key components to the technology and has a precise alignment relationship with the pixel pitch of the display device and a set focal length that must be realized in order for the viewer to perceive the proper 3D impression. This relationship can cause the assembly of a lenticular lens based auto-stereoscopic 3D display device (especially large format) to be tedious, cumbersome and time consuming. Conventionally, the lens requirements and production work flows have made it difficult for high volume production.

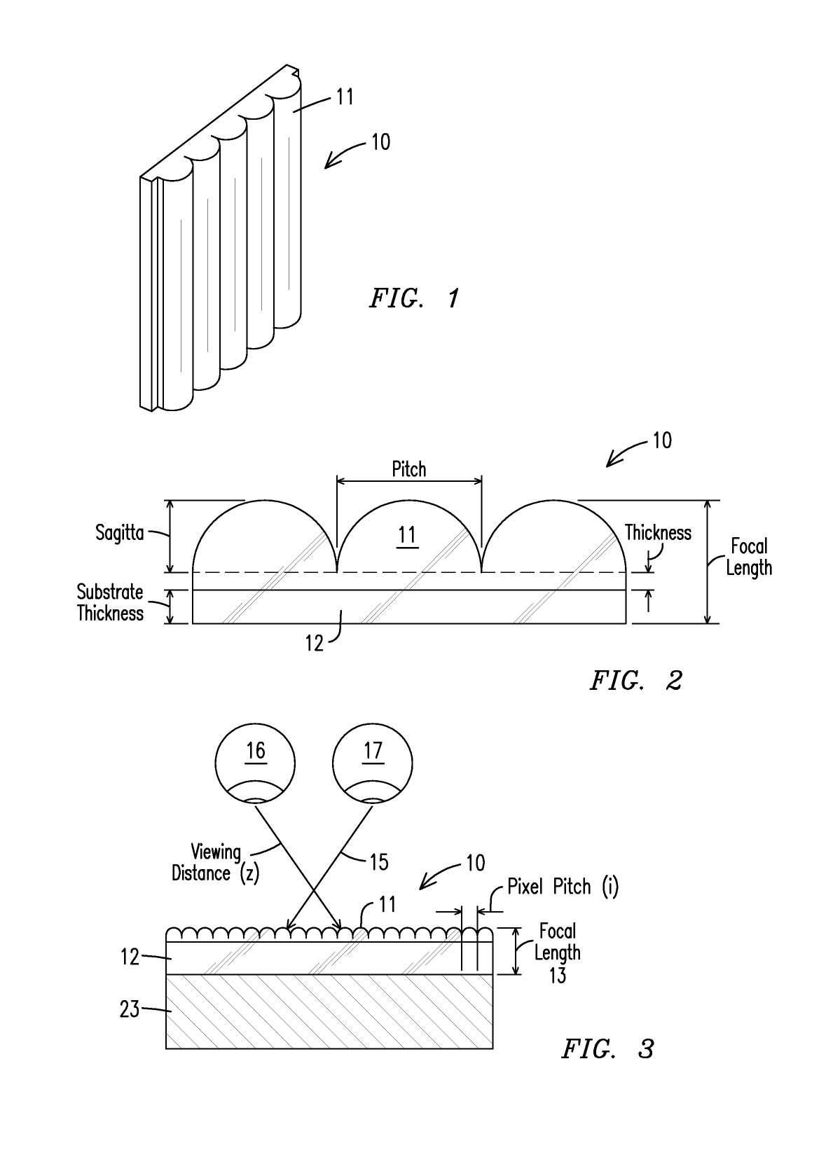

In the present application as seen in FIG. 2, a lenticule is a single optical element 11 on a lenticular sheet in a lens array 10. Pitch is the width of each lenticule while sagitta is the depth or thickness of the surface curve at a given diameter. Focal length includes the thickness and substrate thickness. Lenses per inch (LPI) is the count of lenticules per inch in a lenticular sheet.

A lenticular lens 10 is a fiat sheet of cast resin including an array of cylinder-shaped optical elements (lenticules) as illustrated in FIGS. 1-6. When viewed from different angles, different areas under the lens are magnified. Conventionally, the lenticular lens 10 is laminated to a thick transparent substrate 12 prior to assembly of the auto-stereoscopic 3D display device. The substrate 12 is used as a rigid support and to add the proper focal length 13 for the lens. If the lens moves from the aligned position it will cause distortions in the visual 3D impression. Therefore, it is desirable for the lens to be fixed in position. Depending on the pixel pitch 14 of the display device 18, viewing distance 15 and the approximate average pupil distance 16 of the viewer's eyes 17, the approximate optimal focal length 13 for the lens could be significantly greater than what is desired for production.

Using a 47″ 3D display as an example (FIG. 3), the relationship between the minimal lens focal length (f), the viewing distance (z), the pixel pitch (i) and an average viewer pupil distance (e) can be expressed by the following:

$$z = f ( \frac{e}{i} + 1 )$$

Where the viewing distance (z)=6 feet (˜1,828.8 mm), (e)=˜2.5 inches (˜63.5 mm) and (i)=˜0.02132 inches (0.5415 mm), then the focal length (f) is calculated to be ˜0.60866 inches (15.46 mm). This would indicate that from the top of the lense curve to the screen of the display device the approximate optimum focal length would be 0.60866 inches. Furthermore, if you are employing a glass substrate into your design it would increase the devices weight substantially. In this example regarding the 47″ 3D display's additional weight, we can ascertain the approximate weight by using the 2.5 kg per millimeter per square meter formula which is expressed as width in meters×height in meters×thickness in millimeters×2.5 kilograms. The substrate for the 47″ display is ˜1083.6 mm (1.0836 m) wide×˜628.8 mm (0.6288 m) height×15.46 mm thickness×2.5 kg is calculated to be ˜26.33 kg (58 lbs). During production design this additional weight must be considered.

The second most critical feature of the technology is the mathematics to properly draw an image on the display device (know as interlacing). In this process, We consider each row of the output image as a row of sub-pixels R, G, or B (determined by the display manufacture). The number of sub-pixels being covered by a single line of the lenticular lens at the slant angle chosen, determines the number of views available in the lens viewing cone. Using information on the width of a lens line, the angle of the lens slant, and the offset of the top-left corner first lens line, we can compute for each sub-pixel in a row what view the sub-pixel corresponds to. Based on the view determined from the above calculation, we get the appropriate R, G, or B (as appropriate for the sub-pixel being sampled) from the source view image. This is key to produce the proper dimensional impression. These calculations are processed in realtime with our 3D motherboard.

In accordance with an embodiment of the invention, unique components are assembled to create a 3D auto-stereoscopic production unit which can advantageously reduce the manufacturing time to precisely position a lenticular lens 10 to a display device 18, reduce alignment issues, reduce weight issues and bulkiness that can occur by using a heavy substrate to support the lens, enhance the speed of mounting the lenticular lens 10 to the display device 16 while maintaining accuracy and allowing for high yield production runs, mount the lens in a locked long-term position that will not change over time due to poor bonding methods, enable the ability to remove the mounted lens from the display device without damaging the display device. This latter aspect includes the ability to replace a lens onsite or offsite (the auto-stereoscopic 3D display device).

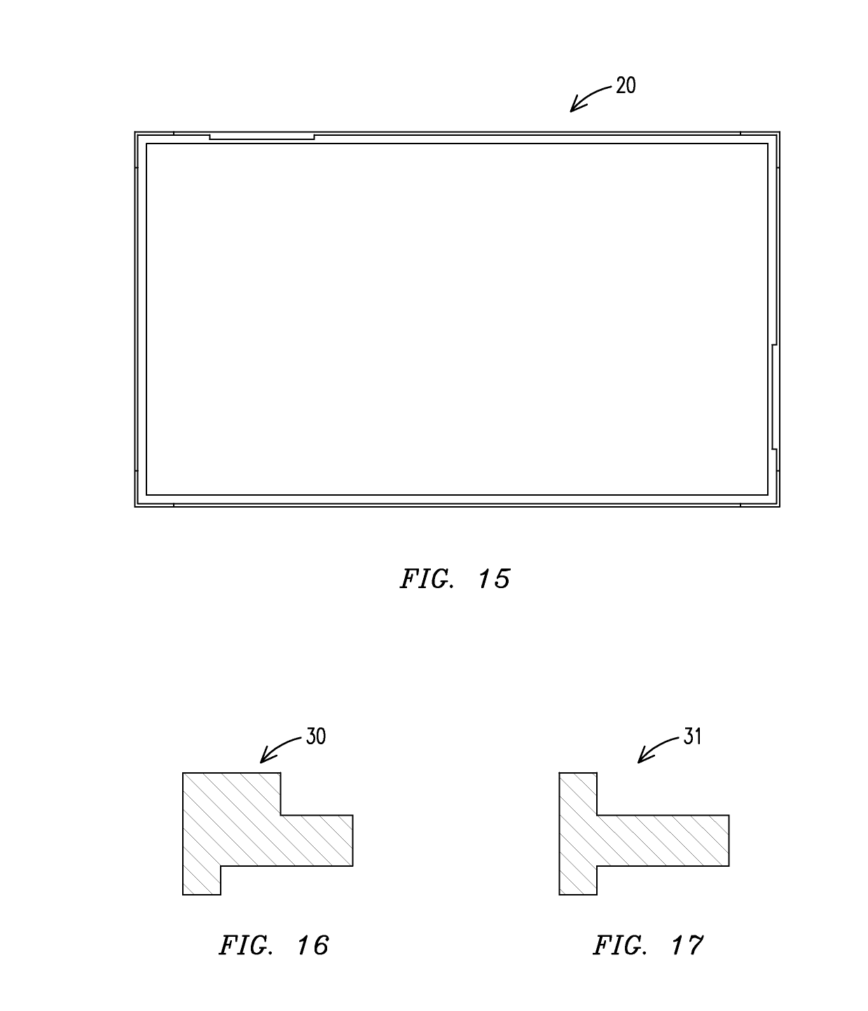

Reference is now made to the drawings, FIGS. 1 through 17 that illustrate preferred embodiments of the invention.

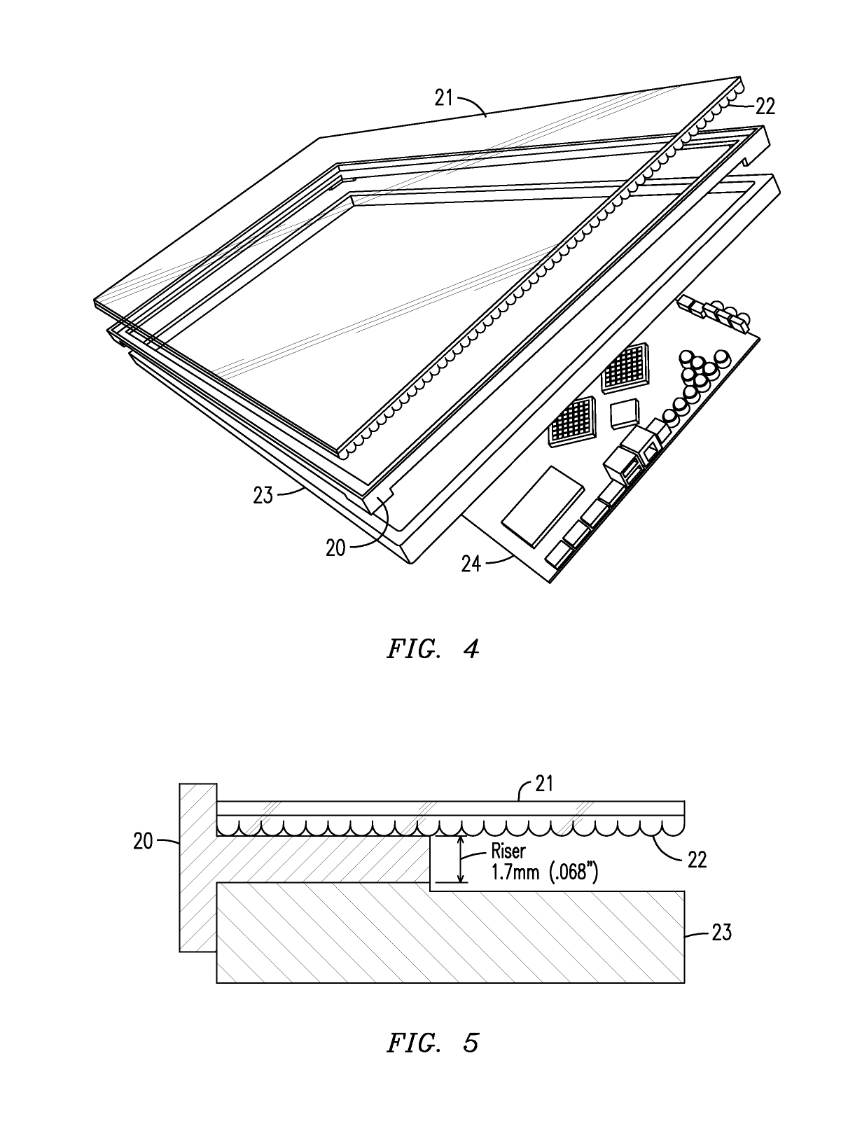

FIG. 4 is an exploded view of the 3D display which includes the invention which is the registration riser 20, the register substrate 21, lenticular lens 22, display panel 23 and 3D motherboard 24. The lens 22 is laminated to the substrate 21 which uses a registration system to lock it into position with the riser 20. Once aligned with the riser 20, the substrate 21 and lens 22 are bonded to the riser 20 with a UV curing epoxy. The riser 20 is then attached to the panel 23 of the display device. This riser 20 mount is detachable and will not damage the display device. The riser is snapped onto the display and held thereto with small screws to keep it from moving. The overall production design is precise and extremely quick to assemble. The 3D motherboard 24 is mounted to the display panel 23. The lenticular lens 21 of the present invention as seen in FIG. 5 is mounted the reverse of the normal mounting of the normal prior art lenticular lens 10 illustrated in FIG. 3 so that the substrate 21 supporting the lenticular lens 21 is positioned on the opposite side of the lens 21 from the riser 20.

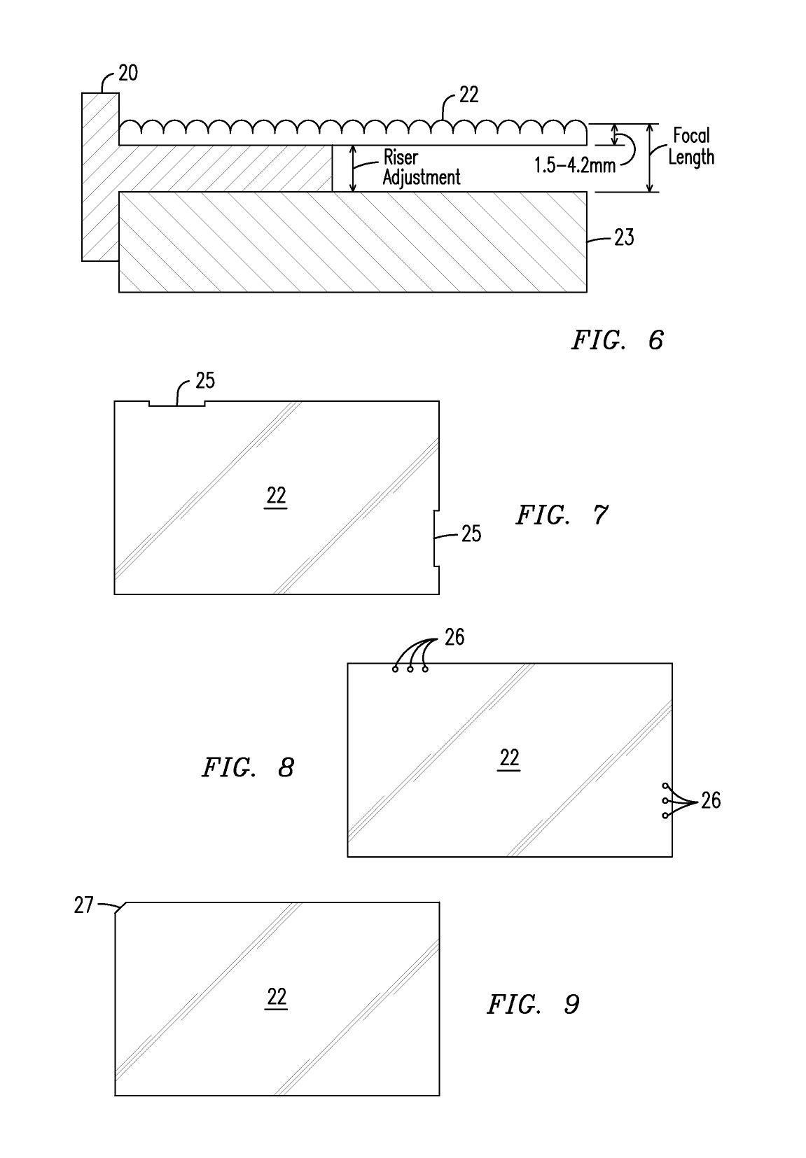

FIGS. 5 and 6 illustrate the use of the riser 20 height to ensure proper focal length while reducing weight and thickness of the lens array. This is important while calculating additional load bearing weight to the overall device design and ease of assembly during production. The substrate and lens are preferably between approximately 1 to 8 mm in thickness. For the example of the 47″ display, the preferred thickness is 1.5-4.2 mm. Typically this system would meet the correct focal length for the lens and weigh approximately 6 lbs including the riser 20.

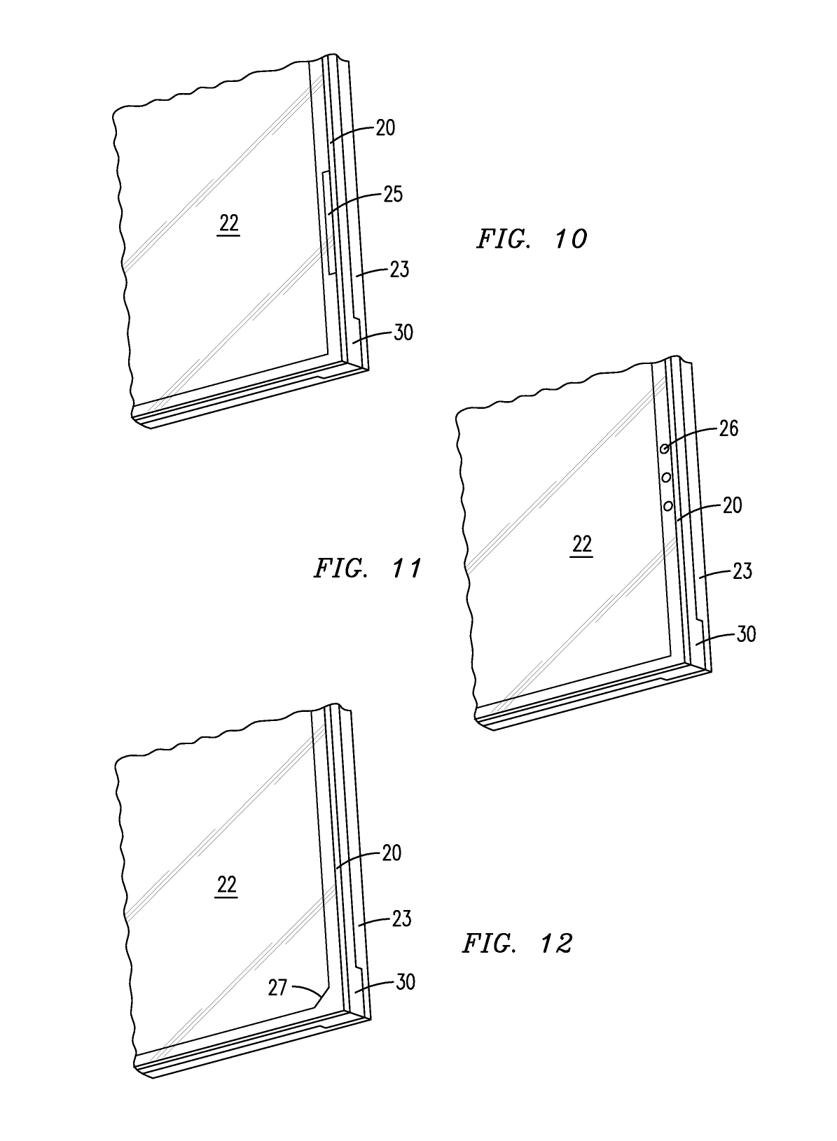

FIGS. 7, 8 and 9 illustrates a registration design. The lens substrate array employs a unique system designed to make it a keyed/registered component. Embodiments include three designs with different registration features: the tab method (FIG. 7) having tabs 25, the pin method (FIG. 8) having pins and the dog eared method (FIG. 9) having dog eared corners 27. In addition, the registration position is applied to the lens lamination process ensuring the proper position of the lenticular lens 22. Once the lens substrate is aligned, it is permanently bonded to the riser using a UV curing epoxy.

FIGS. 10, 11 and 12 illustrate the application of the lens registration feature. The registration locks the lens 22 into position according to the optimum relationship parameters between the display device 23 and the lens 22. This system precisely positions the lens 22 to the display device 23 and makes sure that it is in the proper facing position.

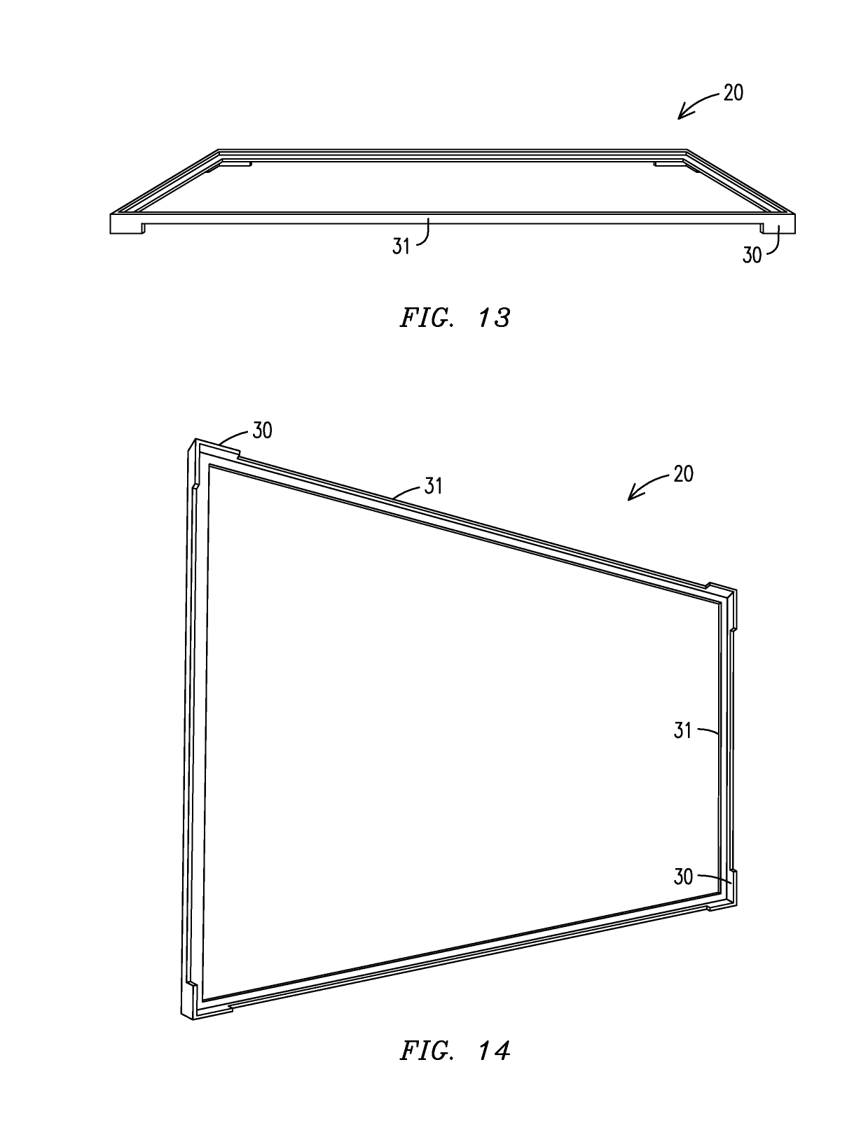

FIGS. 13, 14 and 15 illustrates a riser 20 design. The riser 20 is unique to each lenticular lens array 22 and display device 23. It is preferably constructed from plastic, metal, or the like. It has four corner mount angles 30, shown in cross-section in FIG. 16 that snap down on the display device 23 and a lip 31, shown in cross-section in FIG. 17, that runs along the entire perimeter of the display device ensuring a rigid and secure mount.

Some advantages of the invention are now described. Not all of these advantages are required by all embodiments of the invention. Use of the riser allows one to create a high yield manufacturing pipeline to produce 3D lenticular lens display devices. It also reduces the overall weight of a large format 3D lenticular lens display device relative to conventional designs. While minimizing weight, however, one can still maintain the proper focal length and use a thin substrate to support the lens. The riser allows one to precisely register a lenticular lens array to the display device during manufacturing using a keyed registration system and locks the lenticular lens into position to reduce lens alignment errors and ensure long-term position alignment. The riser 20 allows one to precisely mount and secure a lenticular lens 22 to a display device 23 without bonding the lens 22 directly to the display device 23. The riser 20 is removably mountable to the lenticular lens 22, so if the lens 22 is damaged and/or not at the required specifications, it can be replaced without damaging the display device 23.

The invention has been described above with reference to preferred embodiments. Unless otherwise defined, all technical terms used herein are intended to have the same meaning as commonly understood in the art to which this invention pertains and at the time of its filing. Although various methods and materials similar or equivalent to those described herein can be used in the practice or testing of the present invention, suitable methods and materials are described. However, the skilled should understand that the methods and materials used and described are examples and may not be the only ones suitable for use in the invention. Accordingly, this invention may be embodied in many different forms and should not be construed as limited to the embodiments set forth herein. Rather, these embodiments are provided so that this disclosure will convey the preferred embodiments of the invention to those skilled in the art. The invention has been described in some detail, but it will be apparent that various modifications and changes can be made within the spirit and scope of the invention as described in the foregoing specification.

We claim:

1. A method of making a three dimensional image display having the steps of:
selecting an image display panel having a face for displaying visual images;
selecting a transparent substrate having predetermined registration alignment guides;
selecting a lenticular lens array sized to cover said display panel;
laminating said lenticular lens array to said transparent substrate;
selecting a registration riser sized to fit around the periphery of said display panel and having a predetermined shape for spacing said substrate and attached lenticular lens array relative to the face of said display panel by a distance to focus said lenticular lens on said display panel;
attaching said substrate and attached lenticular lens array to said registration riser aligned by said predetermined registration alignment guides;
removably attaching said registration riser and attached substrate and lenticular lens array to said display panel to cover the face of said display panel and positioned on said display panel by a distance to focus said lenticular lens on the face of said display panel to allow viewing of three dimensional images displayed on said display panel;
whereby a lenticular lens is removably mounted over the face of a display panel for easy removably and replacement without losing its alignment relative to the display panel.

2. The method of making a three dimensional image display in accordance with claim 1 in which the step of selecting a transparent substrate having alignment guides includes selecting a transparent substrate having a plurality of alignment guide notches matching registration riser tabs.

3. The method of making a three dimensional image display in accordance with claim 1 in which the step of selecting a transparent substrate having alignment guides includes selecting a transparent substrate having a plurality of alignment guide registration pin holes matching registration riser pins.

4. The method of making a three dimensional image display in accordance with claim 1 in which the step of selecting a transparent substrate having alignment guides includes selecting a transparent substrate having a plurality of alignment guides having a plurality of dog eared corners matching registration riser corners.

5. The method of making a three dimensional image display in accordance with claim 2 in which the step of selecting a transparent substrate having alignment guides includes selecting a transparent substrate having an alignment notch on two sides thereof matching registration riser tabs on two sides thereof.

6. The method of making a three dimensional image display in accordance with claim 3 in which the step of selecting a transparent substrate having alignment guides includes selecting a transparent substrate having alignment guides having two sets of alignment registration pin holes matching two sets of registration riser pins.

7. The method of making a three dimensional image display in accordance with claim 4 in which the selected transparent substrate alignment guides has two dog eared corners matching two registration riser corners.

8. The method of making a three dimensional image display in accordance with claim 1 in which the step of selecting a registration riser includes selecting a registration riser having a plurality of right angle corners for aligning said registration riser with said display panel.

9. The method of making a three dimensional image display in accordance with claim 8 including attaching said display panel to a motherboard for generating an image for three dimension viewing through said lenticular lens.

10. A three dimensional image display comprising:
an image display panel having a face for displaying visual images;
a registration riser sized to fit around the periphery of said display panel and removably attached to said display panel;
a transparent substrate having a plurality of alignment guides;
a lenticular lens array sized to cover said display panel, said lenticular lens array being laminated to said transparent substrate;
said transparent substrate having said lenticular lens array laminated thereto being attached t said registration panel aligned by said substrate alignment guides to position the attached substrate and lenticular lens array relative to the face of said display panel by a distance to focus said lenticular lens on said display panel for viewing three dimensional images;
whereby a lenticular lens for viewing a three dimensional image on a display panel can be easily attached and detached from a display panel while maintaining its alignment relative to said display panel.

11. The three dimensional image display in accordance with claim 10 in which said transparent substrate plurality of alignment guides includes a plurality of alignment guide notches matching as plurality of registration riser tabs.

12. The three dimensional image display in accordance with claim 10 in which said transparent substrate plurality of alignment guides includes a plurality of alignment guide registration pin holes matching a plurality of registration riser pins.

13. The three dimensional image display in accordance with claim 10 in which said transparent Substrate plurality of alignment guides includes a plurality of alignment guide registration having a plurality of dog eared corners matching registration riser corners.

14. The three dimensional image display in accordance with claim 10 in which said display panel has a motherboard operative connected thereto for generating an image for three dimension viewing through said lenticular lens.

15. The three dimensional image display in accordance with claim 10 in which said registration riser has a plurality of right angle corners for aligning said registration riser with said display panel.
